(19) United States
(12) Patent Application Publication
(10) Pub. No.: US 2007/0063938 A1
(43) Pub. Date: Mar. 22, 2007

(54) DRIVING METHOD FOR PIXLES

(76) Inventors: Da-Shuang Kuan, Hsinchu County (TW); Tony Whitehead, Hsinchu City (TW); Chia-Tsung Chan, Taoyuan County (TW); Chia-Te Lin, Chiayi County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,645

(22) Filed: Sep. 18, 2005

(51) Int. Cl. G09G 3/36

(52) U.S. Cl. 345/87

(57) ABSTRACT

A pixel driving method is provided. The driving method includes selecting subpixels from different frame periods with different selecting modes in order to form a pixel array, and driving the pixel array. Different pixel arrays that are formed with subpixels selected from different frame periods are shifted by a distance of one subpixel along the row direction, the column direction, or both directions from each other. Thus, the image resolution of a display panel is improved.

### BACKGROUND OF THE INVENTION

1. Field of the Invention

The present invention relates to a driving method, and more particularly, to a pixel driving method for improving image resolution of a display panel.

2. Description of Related Art

As computer capacity is rapidly increased, and Internet and multi-media technology is highly developed, image information is usually transmitted by digital method instead of analog method. In order to comply with modern life style, video or image apparatus are becoming thinner and lighter. Since a conventional cathode ray tube (CRT) display is equipped with an electron cavity, a volume of the display is large and is space inefficient, whereas radiation therefrom is harmful to users. Therefore, a flat panel display is being developed by applying optoelectronic technology and semiconductor process technology, such as liquid crystal display (LCD), organic light emitting display (OLED), or plasma display panel (PDP), etc., which are presently dominating the display market.

As to a LCD, image display is usually categorized into direct view, such as liquid crystal monitor, digital liquid crystal television, and indirect view, such as liquid projector, rear projecting TV. In recent year, a liquid crystal display is developed as full colored, having larger panel dimension, providing high resolution and low cost, whereas direct view display still redeems panel dimension with cost. It is noted that a reflective micro display panel, e.g. a liquid crystal on silicon display panel (LCOS display panel) with high resolution, equipped with an optical engine to achieve larger dimensional liquid crystal projector and rear projecting TV, is becoming the present development trend.

An LCOS display panel is a reflective liquid crystal panel structured over a silicon substrate, on which MOS transistors are adapted for controlling liquid crystal layer over pixel electrodes. Moreover, the pixel electrode of the LCOS display panel is metallic, thus incidence light are transmitted through the liquid crystal layer and the color filter before being reflected to display. Since the LCOS display panel is formed over a silicon substrate, its volume efficiency and high resolution are superior to conventional direct view display panel, complying with large dimension projecting display.

A liquid crystal display usually transforms an analog video signal from the host system to a corresponding digital video signal via an interface circuit, and drives a plurality of pixels arranged in array on a display panel. Wherein each pixel is composed of a plurality of subpixels located at fixed positions correspondingly, wherein each pixel includes, for example, red, green and blue subpixels, for displaying different colors after light mixing.

Generally speaking, resolution of a display panel is determined by a number of pixels within a specific display area. Providing more pixels in a same size of image, the image has better resolution. However, a conventional reflective micro display panel, e.g. LCOS display panel, is limited to pixel composition and driving method thereof, thus resolution of image is limited.

### SUMMARY OF THE INVENTION

The present invention is related to a driving method for pixels of a display panel. Different subpixels are selected from different frame periods for forming a pixel array, such that better image resolution is provided, and display quality of the display panel is increased.

According to one embodiment of the present invention, a pixel driving method is provided for a display panel having a plurality of subpixels arranged in an array. The pixel driving method, according to the present invention, includes selecting subpixels from a plurality of frame periods to form a plurality of pixels, and driving the pixels. Wherein the method of selecting the subpixels includes at least two selection modes chosen from the following:

For a first selection mode, the subpixel S_{2K-1,2L-1}, the subpixel S_{2K,2L-1}, the subpixel S_{2K-1,2L}, and the subpixel S_{2K,2L} for forming the pixel P_{K,L} are selected, wherein the subpixel S_{2K,2L} is a subpixel located at 2K^{th} column and 2L^{th} row, and the pixel P_{K,L} is a pixel located at K^{th} column and L^{th} row formed with the subpixels, where K and L are integers.

For a second selection mode, the subpixel S_{2K-1,2L}, the subpixel S_{2K,2L}, the subpixel S_{2K-1,2L+1}, and the subpixel S_{2K,2L+1} are selected for forming the pixel P_{K,L}.

For a third selection mode, the subpixel S_{2K,2L-1}, the subpixel S_{2K+1,2L-1}, the subpixel S_{2K,2L}, and the subpixel S_{2K+1,2L} are selected for forming the pixel P_{K,L}.

For a fourth selection mode, the subpixel S_{2K,2L}, the subpixel S_{2K+1,2L}, the subpixel S_{2K,2L+1}, and the subpixel S_{2K+1,2L+1} are selected for forming the pixel P_{K,L}.

According to one embodiment of the present invention, the method of selecting the subpixels includes performing the first selection mode and the second selection mode.

According to another embodiment of the present invention, the method of selecting the subpixels includes performing the first selection mode and the fourth selection mode.

According to yet another embodiment of the present invention, the method of selecting the subpixels includes performing the first selection mode, the second selection mode, and the third selection mode.

According to yet another embodiment of the present invention, the method of selecting the subpixels includes performing the first selection mode, the second selection mode, and the fourth second selection mode.

According to yet another aspect of the present invention, the method of selecting the subpixels includes performing the first selection mode, the second selection mode, the third selection mode, and the fourth selection mode.

According to the above descriptions, the pixel driving method in the present invention includes selecting different subpixels from different frame periods for forming a pixel array, and driving the pixel array. Wherein when different pixel array is shifted by one subpixel along the column direction or the row direction, or by one subpixel along both directions of the pixel array, image resolution of the display panel is improved. Thus, the pixel driving method, according to an embodiment of the present invention, is capable of substantially improving the image resolution of the display panel.

### BRIEF DESCRIPTION OF THE DRAWINGS

FIG. 1 is a schematic block diagram illustrating a pixel driving method according to a first embodiment of the present invention.

FIG. 2 is a schematic block diagram illustrating a pixel driving method according to a second embodiment of the present invention.

FIG. 3 is a schematic block diagram illustrating a pixel driving method according to a third embodiment of the present invention.

FIG. 4 is a schematic block diagram illustrating a pixel driving method according to a fourth embodiment of the present invention.

FIG. 5 is a schematic block diagram illustrating a pixel driving method according to a fifth embodiment of the present invention.

FIG. 6 is a schematic block diagram illustrating a pixel driving method according to a sixth embodiment of the present invention.

### DESCRIPTION OF THE EMBODIMENTS

The First Embodiment

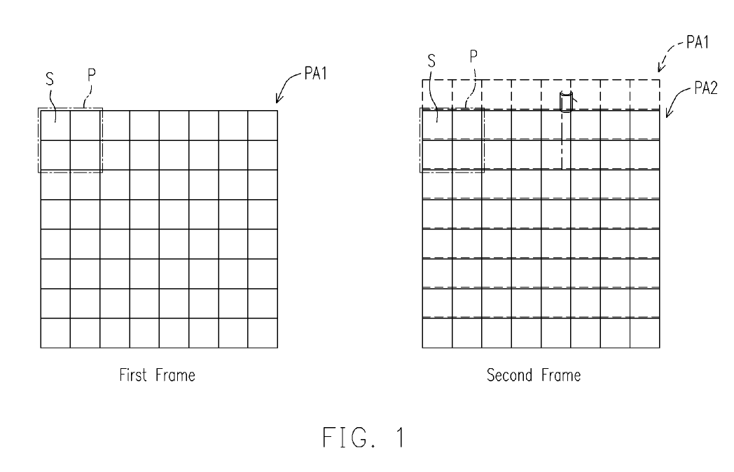

Referring to FIG. 1, it illustrates a block diagram of pixel driving method according to a first embodiment of the present invention. A display panel (not illustrated) includes a plurality of subpixels S arranged in an array, for example.

In the first frame period, the subpixel S_{2K-1,2L-1}, the subpixel S_{2K,2L-1}, the subpixel S_{2K-1,2L}, and the subpixel S_{2K,2L} are selected as a pixels P_{K,L} according to a first selection mode so as to form a pixel array PA1, and the pixel array PA1 is driven by this first selection mode. Wherein the subpixel S_{2K,2L} is a subpixel located at the 2K^{th} column and the 2L^{th} row, and the pixel P_{K,L} is a pixel located at K^{th} column and L^{th} row formed with the subpixels, where K and L are integers.

Thereafter, in the second frame period, the subpixel S_{2K-1,2L}, the subpixel S_{2K,2L}, the subpixel S_{2K-1,2L+1}, and the subpixel S_{2K,2L+1} are selected as a pixels P_{K,L} according to a second selection mode so as to form a pixel array PA2, and the pixel array PA2 is driven by this second selection mode. Wherein the pixel array PA2 is shifted by a distance of a subpixel S with respect to the pixel array PA1 along the column direction.

The pixel driving method mentioned above includes selecting subpixels by performing different selection modes, so that a pixel array of one frame period is shifted by a distance of a subpixel with respect to that of another frame period. Therefore, adjacent pixels are overlapped with a subpixel in different frames, providing trimming effect at image edge, and a better image quality along the column direction is obtained.

The Second Embodiment

According to a second embodiment of the present invention, the pixel driving method comprises shifting a pixel array of one frame period by a distance of a subpixel with respect to that of another frame period along the row direction.

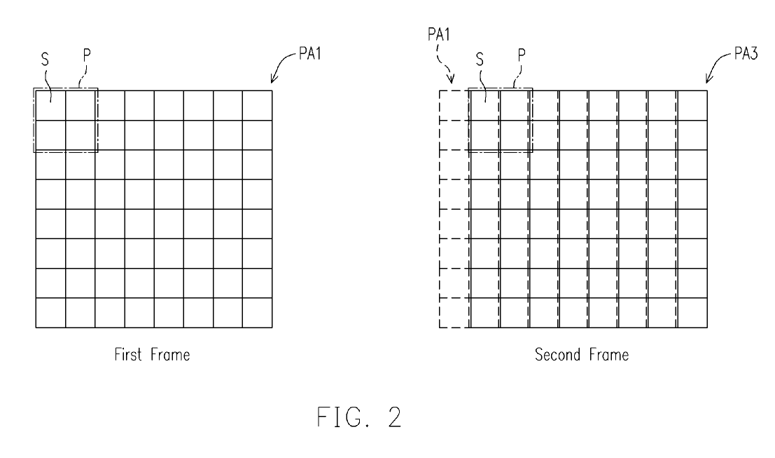

Referring to FIG. 2, it illustrates a block diagram of pixel driving method according to a second embodiment of the present invention.

First, in the first frame period, the subpixel S_{2K-1,2L-1}, the subpixel S_{2K,2L-1}, the subpixel S_{2K-1,2L}, and the subpixel S_{2K,2L} are selected as a pixels P_{K,L} according to a first selection mode so as to form a pixel array PA1, and the pixel array PA1 is driven by this first selection mode.

Thereafter, in the second frame period, the subpixel S_{2K,2L-1}, the subpixel S_{2K+1,2L-1}, the subpixel S_{2K,2L}, and the subpixel S_{2K+1,2L} are selected as a pixels P_{K,L} according to a third selection mode so as to form a pixel array PA3, and the pixel array PA3 is driven by this third selection mode. Wherein the pixel array PA3 is shifted by a distance of a subpixel S with respect to the pixel array PA1 along the row direction.

The pixel driving method according to the second embodiment of the present invention provides better image quality of the display panel along the row direction.

The Third Embodiment

According to a third embodiment of the present invention, the pixel driving method comprises shifting a pixel array of one frame period by a distance of a subpixel along both the column and the row directions.

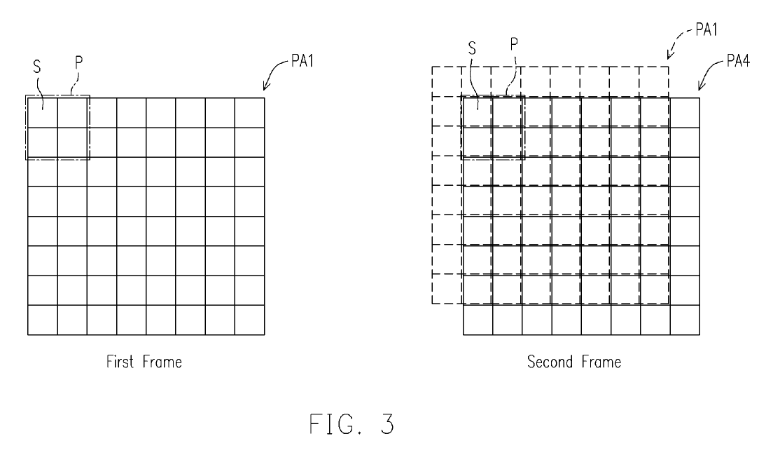

Referring to FIG. 3, it illustrates a block diagram of pixel driving method according to a third embodiment of the present invention.

Firstly, in the first frame period, the subpixel S_{2K-1,2L-1}, the subpixels S_{2K,2L-1}, the subpixel S_{2K-1,2L}, and the subpixel S_{2K,2L} are selected as a pixels P_{K,L} according to a first selecting mode so as to form a pixel array PA1, which includes a plurality of the pixels P_{K,L}, and the pixel array PA1 is driven by this mode.

Thereafter, in the second frame period, the subpixel S_{2K,2L}, the subpixel S_{2K+1,2L}, the subpixel S_{2K,2L+1}, and the subpixel S_{2K+1,2L+1} are selected as a pixels P_{K,L} according to a fourth selecting mode so as to form a pixel array PA4, which includes a plurality of the pixels P_{K,L}, and the pixel array PA4 is driven by this mode. Wherein the pixel array PA4 is shifted by a distance of a subpixel S with respect to the pixel array PA1 along both the column and the row directions.

The pixel driving method according to the third embodiment of the present invention provides better image quality of the display panel along both the column the row directions.

The foregoing first embodiment, second embodiment and third embodiment provide different selection modes for improving image resolutions along different directions. It is noted that multiple selection modes can be optionally combined to obtain a plurality of pixel driving methods as described hereinafter.

The Fourth Embodiment

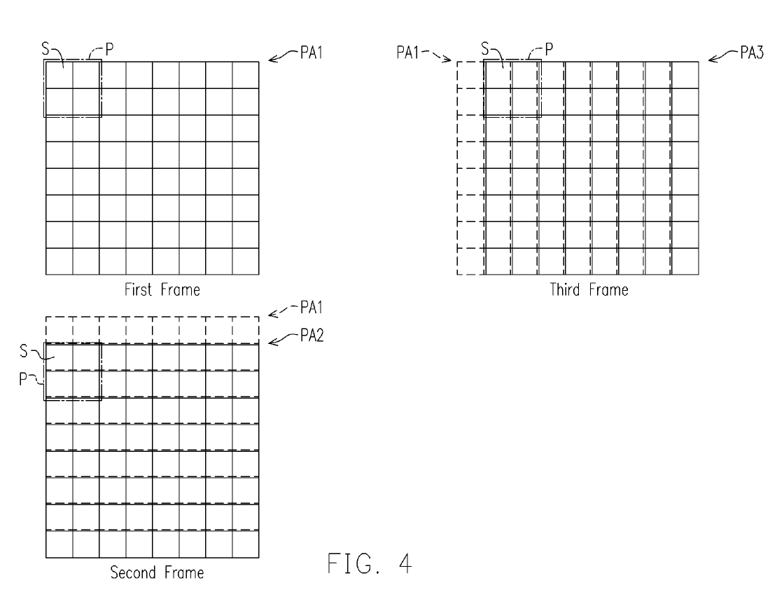

Referring to FIG. 4, a schematic block diagram of pixel driving method according to a fourth embodiment of the present invention is shown. In this embodiment, the first selection mode, the second selection mode and the third selection mode described above are sequentially performed for selecting subpixels.

First, a pixel array PA1 is formed in accordance with the first selection mode in the first frame period, and the pixel array PA1 is driven by this first selection mode. And then, a pixel array PA2 is formed in accordance with the second selection mode in the second time period, and the pixel array PA2 that is shifted by a subpixel distance S downwards the pixel array PA1 is driven by this second selection mode. Thereafter, a pixel array PA3 is formed in accordance with the third selecting mode in the third time period, and the pixel array PA3 that is shifted by a subpixel distance S with respect to the pixel array PA1 towards right is driven by this third selection mode.

The Fifth Embodiment

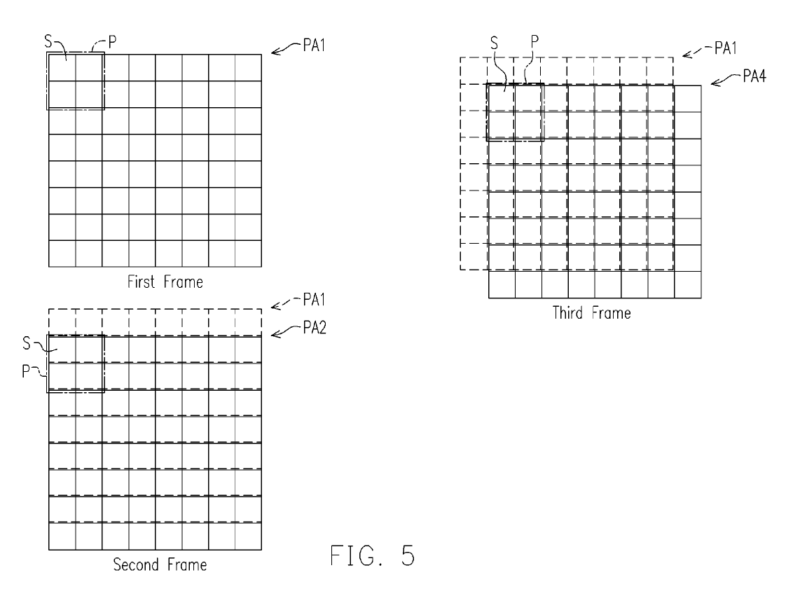

Referring to FIG. 5, a schematic block diagram of pixel driving method according to the fifth embodiment of the present invention is shown. In this embodiment, the first selection mode, the second selection mode and the fourth selection mode described above are sequentially performed for selecting subpixels.

First, a pixel array PA1 is formed in accordance with the first selection mode in the first frame period, and the pixel array PA1 is driven by this first selection mode. And then, a pixel array PA2 is formed in accordance with the second selection mode in the second time period, and the pixel array PA2 that is shifted by a subpixel distance S downwards the pixel array PA1 is driven by this second selection mode. Thereafter, a pixel array PA4 is formed in accordance with the fourth selection mode in the fourth time period, and the pixel array PA4 that is shifted by a subpixel distance S with respect to the pixel array PA1 towards both downwards and right is driven by this fourth selection mode.

The Sixth Embodiment

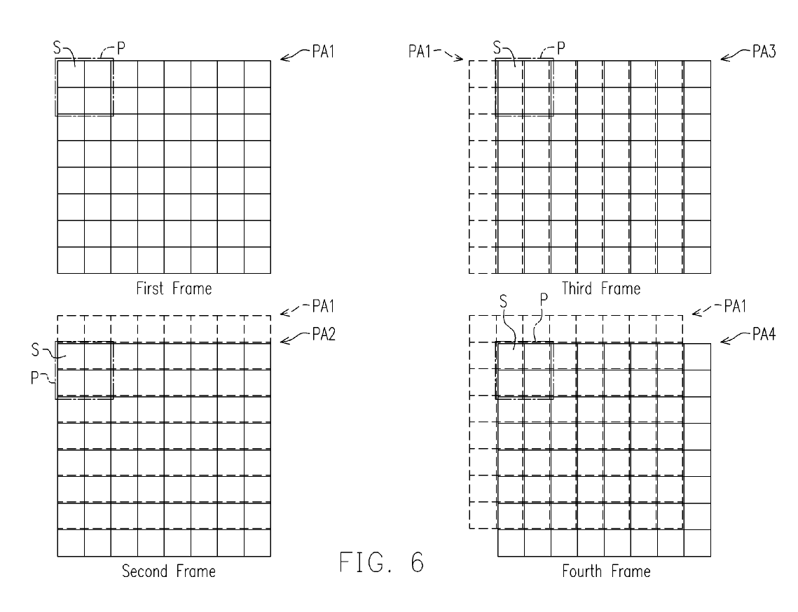

Referring to FIG. 6, a schematic block diagram of pixel driving method according to the sixth embodiment of the present invention is shown. In this embodiment, the first selection mode, the second selection mode, the third selection mode and the fourth selection mode described above are sequentially performed for selecting subpixels.

First, a pixel array PA1 is formed in accordance with the first selection mode in the first frame period, and the pixel array PA1 is driven by this first selection mode. And then, a pixel array PA2 is formed in accordance with the second selection mode in the second time period, and the pixel array PA2 that is shifted by a subpixel distance S downwards the pixel array PA1 is driven by this selection mode. Thereafter, a pixel array PA3 is formed in accordance with the third selection mode in the third time period, and the pixel array PA3 that is shifted by a subpixel distance S with respect to the pixel array PA1 towards right is driven by this third selection mode. Then, a pixel array PA4 is formed in accordance with the fourth selection mode in the fourth time period, and the pixel array PA4 that is shifted by a subpixel distance S with respect to the pixel array PA1 towards both downwards and right is driven by this fourth selection mode.

According to the above description, the present invention provides a pixel driving method for increasing image resolution of a display panel, and further providing better display quality. It is noted that the above embodiments are exemplary yet not limiting a combination and a sequence of selecting modes, such that more variety of pixel driving methods are developed.

Although the invention has been described with reference to a particular embodiment thereof, it will be apparent to those skilled in the art that modifications to the described embodiment may be made without departing from the spirit of the invention. Accordingly, the scope of the invention will be defined by the attached claims and not by the above detailed description.

What is claimed is:

1. A pixel driving method, for driving a display panel, the display panel having a plurality of subpixels arranged in an array, the pixel driving method comprising:
selecting the subpixels respectively from a plurality of frame periods to form a plurality of pixels, wherein a method of selecting the subpixels comprises at least two selection modes from a group consisting:
a first selection mode, for selecting a subpixel S_{2K-1,2L-1}, a subpixel S_{2K,2L-1}, a subpixel S_{2K-1,2L} and a subpixel S_{2K,2L} for forming a pixel P_{K,L}, wherein the subpixel S_{2K,2L} is a subpixel located at a 2K^{th} column and a 2L^{th} row, and the pixel P_{K,L} is a pixel composed of the subpixels that is located at K^{th} column and L^{th} row, where K and L are integers;
a second selection mode, for selecting the subpixel S_{2K-1,2L}, the subpixel S_{2K,2L}, the subpixel S_{2K-1,2L+1}, and the subpixel S_{2K,2L+1} for forming the pixel P_{K,L};
a third selection mode, for selecting the subpixel S_{2K,2L-1}, the subpixel S_{2K+1,2L-1}, the subpixel S_{2K,2L}, and the subpixel S_{2K,2L+1} for forming the pixel P_{K,L};
a fourth selection mode, for selecting the subpixel S_{2K,2L}, the subpixel S_{2K+1,2L}, the subpixel S_{2K,2L+1}, and the subpixel S_{2K+1,2L+1} for forming the pixel P_{K,L}; and
driving the pixels in the frame periods respectively.

2. The pixel driving method as recited in claim 1, wherein the method of selecting the subpixels comprises performing the first selection mode and the second selection mode.

3. The pixel driving method as recited in claim 1, wherein the method of selecting the subpixels comprises performing the first selection mode and the fourth selection mode.

4. The pixel driving method as recited in claim 1, wherein the method of selecting the subpixels comprises performing the first selection mode, the second selection mode, and the third selection mode.

5. The pixel driving method as recited in claim 1, wherein the method of selecting the subpixels comprises performing the first selection mode, the second selection mode, and the fourth second selection mode.

6. The pixel driving method as recited in claim 1, wherein the method of selecting the subpixels comprises performing the first selection mode, the second selection mode, the third selection mode, and the fourth selection mode.
